(19) United States
(12) Patent Application Publication
(10) Pub. No.: US 2026/0361000 A1
(43) Pub. Date: Nov. 12, 2026

(54) CONNECTOR AND MANUFACTURING METHOD OF CONNECTOR

(71) Applicant: SUMITOMO WIRING SYSTEMS, LTD., Mie (JP)

(72) Inventor: Asuka KOBAYASHI, Mie (JP)

(21) Appl. No.: 19/670,356

(22) Filed: May 7, 2026

(30) Foreign Application Priority Data
May 8, 2025 (JP) 2025-078114

(51) Int. Cl. H01R 4/06; H01R 4/70; H01R 43/048

(52) U.S. Cl. CPC H01R 4/06; H01R 4/70; H01R 43/0484

(57) ABSTRACT

A connector includes a nut having a circular outer peripheral surface and a housing made of resin and including a press-fitting portion for holding the outer peripheral surface of the nut, the nut being press-fit into the press-fitting portion. The press-fitting portion includes grooves recessed radially outward to reduce stress to be applied to a weld line extending from an inner peripheral surface of the press-fitting portion at positions shifted toward both sides in a circumferential direction with respect to the weld line.

### CROSS-REFERENCE TO RELATED APPLICATIONS

This application is based on and claims priority from Japanese Patent Application No. 2025-078114, filed on May 8, 2025, with the Japan Patent Office, the disclosure of which is incorporated herein in its entirety by reference.

### TECHNICAL FIELD

The present invention relates to a connector and a manufacturing method of a connector.

### BACKGROUND

Conventionally, a connector is known which is provided with a housing made of resin for holding a terminal and a nut to be fixed in the housing (see, for example, Japanese Patent Laid-open Publication No. 2016-192290). This nut has a circular outer peripheral surface. The housing includes a press-fitting portion, into which the nut is press-fit, to hold the outer peripheral surface of the nut. In such a connector, the nut can be held in the housing without using a fixing member or the like separate from the housing.

### SUMMARY

A weld line may be produced in a housing made of resin depending on the entire shape thereof, the position of a gate at the time of injection molding and the like. The weld line may be produced in a circumferential part of a press-fitting portion. In such a case, the press-fitting portion may be cracked by press-fitting a press-fitting member such as a nut into the press-fitting portion. Note that, if a press-fitting margin of the press-fitting portion and the press-fitting member is reduced to suppress the occurrence of a crack at the weld line, a force for holding the press-fitting member by the press-fitting portion is reduced, wherefore it is not possible to simply reduce the press-fitting margin.

The present disclosure aims to provide a connector and a manufacturing method of a connector capable of suppressing the formation of a crack at a weld line of a press-fitting portion.

The present disclosure is directed to a connector with a press-fitting member having a circular outer peripheral surface and a housing made of resin, the housing including a press-fitting portion for holding the outer peripheral surface of the press-fitting member, the press-fitting member being press-fit into the press-fitting portion, the press-fitting portion including grooves recessed radially outward to reduce stress to be applied to a weld line extending from an inner peripheral surface of the press-fitting portion at positions shifted toward both sides in a circumferential direction with respect to the weld line.

According to the connector and a manufacturing method of a connector of the present disclosure, the occurrence of a crack at a weld line of a press-fitting portion can be suppressed.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view showing a connector in one embodiment.

FIG. 2 is an exploded perspective view of the connector in the embodiment.

FIG. 3 is a plan view of a housing in the embodiment.

FIG. 4 is a bottom view of the housing in the embodiment.

FIG. 5 is a section of the connector in the embodiment.

FIG. 6 is a partial enlarged plan view of the housing in the embodiment.

FIG. 7 is a partial enlarged perspective view of the housing in the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

[1] The connector of the present disclosure is provided with a press-fitting member having a circular outer peripheral surface and a housing made of resin, the housing including a press-fitting portion for holding the outer peripheral surface of the press-fitting member, the press-fitting member being press-fit into the press-fitting portion, the press-fitting portion including grooves recessed radially outward to reduce stress to be applied to a weld line extending from an inner peripheral surface of the press-fitting portion at positions shifted toward both sides in a circumferential direction with respect to the weld line.

According to this configuration, since the press-fitting portion includes the grooves recessed radially outward to reduce stress to be applied to the weld line at the positions shifted toward the both sides in the circumferential direction with respect to the weld line extending from the inner peripheral surface of the press-fitting portion, the occurrence of a crack at the weld line can be suppressed. Thus, for example, the press-fitting member can be stably held.

[2] In [1] described above, the grooves may be arranged on the both sides in the circumferential direction with respect to the weld line to be equidistant from the weld line in the press-fitting portion.

According to this configuration, since the grooves are arranged on the both sides in the circumferential direction with respect to the weld line to be equidistant from the weld line in the press-fitting portion, stress applied to be weld line can be reduced in a well-balanced manner.

[3] In [1] or [2] described above, the press-fitting portion may include an auxiliary groove recessed radially outward so that a part continuously in contact with the outer peripheral surface of the press-fitting member is equal to or less than a half circumference.

According to this configuration, since the press-fitting portion includes the auxiliary groove recessed radially outward so that the part continuously in contact with the outer peripheral surface of the press-fitting member is equal to or less than the half circumference, the press-fitting member can be held in a well-balanced manner. That is, if the press-fitting portion includes a part continuously in contact with the outer peripheral surface of the press-fitting member in a range larger than the half circumference without including the auxiliary groove, it may not be possible to hold the press-fitting member in a well-balanced manner. However, this can be avoided and the press-fitting member can be held in a well-balanced manner.

[4] In any one of [1] to [3] described above, the grooves may be formed in an entire range of the press-fitting portion in a press-fitting direction.

According to this configuration, since the grooves are formed in the entire range of the press-fitting portion in the press-fitting direction, stress applied to the weld line can be further reduced. Thus, the occurrence of a crack at the weld line can be further suppressed.

[5] A manufacturing method of the present disclosure is for a connector with a press-fitting member having a circular outer peripheral surface and a housing made of resin, the housing including a press-fitting portion for holding the outer peripheral surface of the press-fitting member, the press-fitting member being press-fit into the press-fitting portion, and includes a weld line specifying step of specifying a weld line produced in the press-fitting portion by a flow analysis, and an additional groove designing step of additionally designing grooves to be recessed radially outward to reduce stress to be applied to the weld line at positions shifted toward both sides in a circumferential direction with respect to the weld line specified to extend from an inner peripheral surface of the press-fitting portion in the press-fitting portion.

According to this method, the weld line produced in the press-fitting portion is specified by the flow analysis in the weld line specifying step. Then, in the additional groove designing step, the grooves to be recessed radially outward to reduce stress to be applied to the weld line are additionally designed at the positions shifted toward the both sides in the circumferential direction with respect to the weld line specified to extend from the inner peripheral surface of the press-fitting portion in the press-fitting portion. If the connector designed in this way is manufactured, the occurrence of a crack at the weld line can be suppressed, for example, when the press-fitting member is press-fit into the press-fitting portion. Thus, for example, the press-fitting member can be stably held.

### Details of Embodiment of Present Disclosure

A specific example of a connector of the present disclosure is described below with reference to the drawings. For the convenience of description, some components may be shown in an exaggerated or simplified manner in each drawing. Further, a dimension ratio of each part may be different in each figure.

A term "tubular" used in the description of this specification indicates not only a shape formed by a peripheral wall continuous over an entire periphery in a circumferential direction, but also a shape formed by combining a plurality of components and a shape having a cut or the like in a circumferential part such as a C shape. A "tubular" shape is a shape including a through hole in a plan view, and an outer peripheral shape and an inner peripheral shape of the through hole may be the same or different. The "tubular" shape may have a predetermined length along an axial direction, in which a center axis passing through a center of the through hole extends, and that length does not matter. Further, terms such as "first", "second" and "third" in this specification are merely used to distinguish objects and do not rank the objects.

Note that the present invention is not limited to these illustrations, but is represented by claims and intended to include all changes in the scope of claims and in the meaning and scope of equivalents.

### Configuration of Connector 10

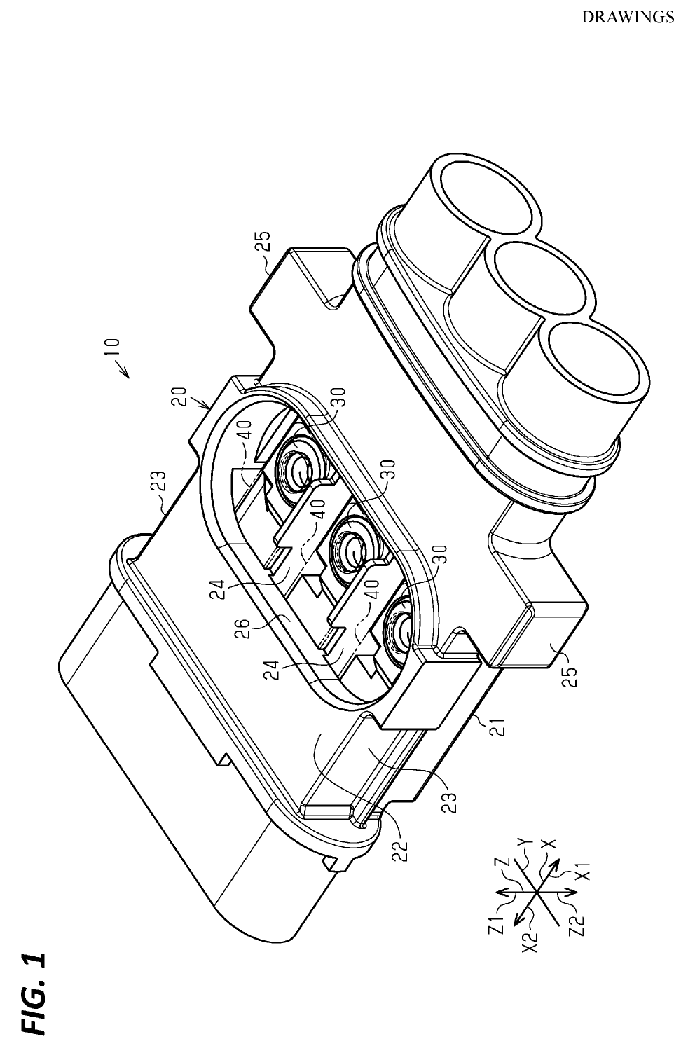

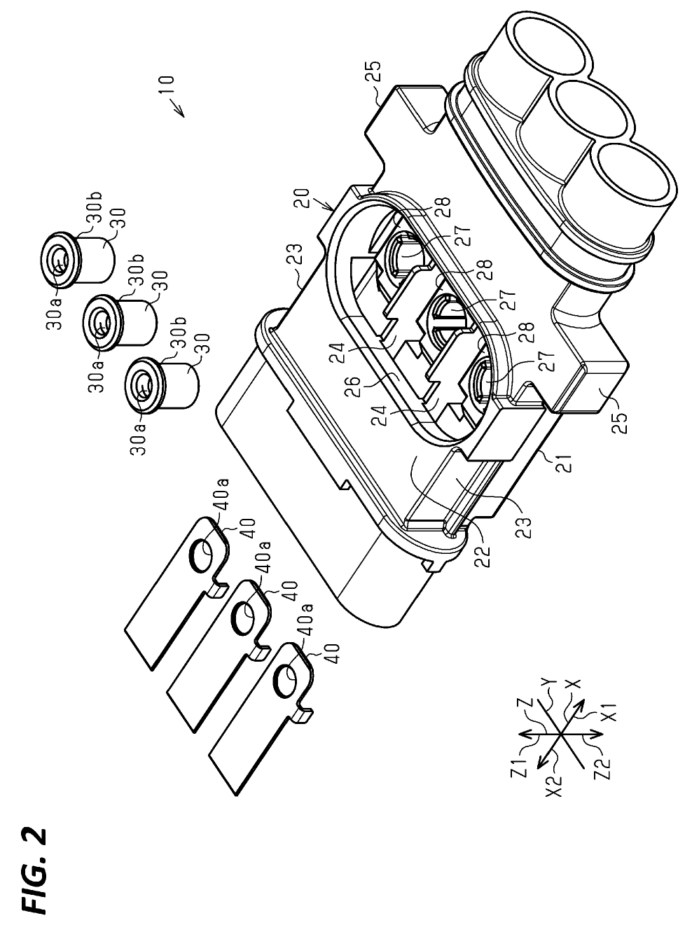

As shown in FIGS. 1 and 2, a connector 10 is provided with a housing 20 and nuts 30 as press-fitting members. The connector 10 of this embodiment is provided with three nuts 30. Note that a first axis X as a through axis, a second axis Y orthogonal to the first axis X and a third axis Z orthogonal to the first and second axes X, Y are shown in each figure. Further, a first direction X1, which is one direction along the first axis X, and a first opposite direction X2, which is a direction opposite to the first direction X1, are shown in figures. Further, an upward direction Z1, which is one direction along the third axis Z, and a downward direction Z2, which is a direction opposite to the upward direction Z1, are shown in figures.

### Configuration of Housing 20

The housing 20 is made of resin.

As shown in FIG. 2, the housing 20 includes a lower wall 21, an upper wall 22, a pair of side walls 23 and two partition walls 24. The lower and upper walls 21, 22 are in the form of plates orthogonal to the third axis Z, and the upper wall 22 is arranged away from the lower wall 21 in the upward direction Z1. The pair of side walls 23 are in the form of plates orthogonal to the second axis Y and connect both end parts along the second axis Y of the lower and upper walls 21, 22. The two partition walls 24 are in the form of plates orthogonal to the second axis Y, and arranged to partition a space between the pair of side walls 23 into three inside the housing 20. Further, the housing 20 of this embodiment includes laterally projecting portions 25 projecting in directions separating from each other along the second axis Y from parts of the pair of side walls 23.

As shown in FIG. 4, the housing 20 of this embodiment includes gate marks 21b in a lower surface 21a. Note that the gate marks 21b are marks produced during the injection molding of the housing 20 and marks produced according to the passage of a molten resin through gates. A total of three gate marks 21b are produced in the respective laterally projecting portions 25 and a center of the lower wall 21 in this embodiment.

As shown in FIGS. 1 - 3, the upper wall 22 includes an opening 26 allowing communication between the inside and outside of the housing 20. In other words, the housing 20 includes the opening 26 open in the upward direction Z1 to allow communication between the inside and outside. The opening 26 is formed in a central part along the first axis X in the upper wall 22. Further, the opening 26 is formed to be long along the second axis Y in the upper wall 22, in particular in an entire range between the pair of side walls 23.

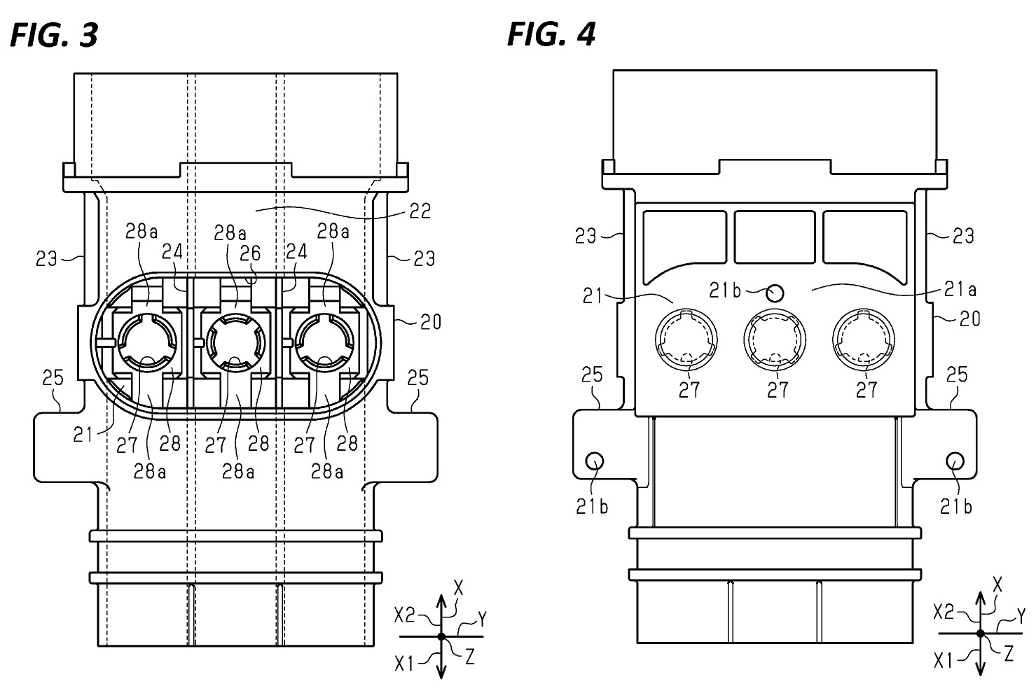

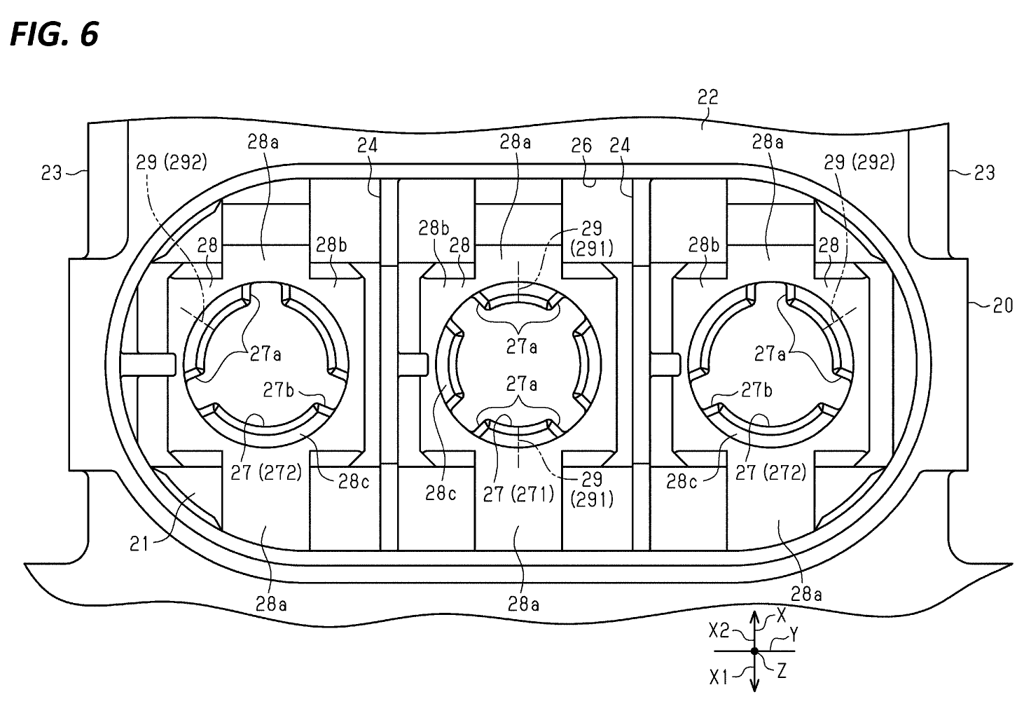

Further, as shown in FIGS. 2 and 3, the lower wall 21 includes press-fitting portions 27, into which the nuts 30 are press-fit, to hold the outer peripheral surfaces of the nuts 30 (see FIG. 2) in a part corresponding to the opening 26. In particular, the lower wall 21 includes projecting portions 28 projecting in the upward direction Z1 in respective parts partitioned by the partition walls 24 in the part corresponding tothe opening 26. As shown in FIG. 6, the projecting portion 28 of this embodiment is formed into a rectangular shape when viewed from the upward direction Z1 and includes extending portions 28a extending to both sides along the first axis X from a center along the second axis Y. The press-fitting portions 27 are recessed in the downward direction Z2 from upper end surfaces 28b of the projecting portions 28.

### Configuration of Nut 30

The nut 30 is made of metal.

As shown in FIG. 2, the outer periphery of the nut 30 is formed into a circular tubular shape. The nut 30 includes an internal thread 30a on an inner peripheral surface. The nut 30 includes a flange portion 30b projecting radially outward from the entire periphery of the upper end.

Further, the connector 10 of this embodiment is provided with three terminals 40 to be accommodated into the housing 20. Each of the three terminals 40 includes a through hole 40a in a tip part. The three terminals 40 are inserted in the first direction X1, which is one direction along the first axis X, and arranged in the respective parts partitioned by the partition walls 24 in the housing 20.

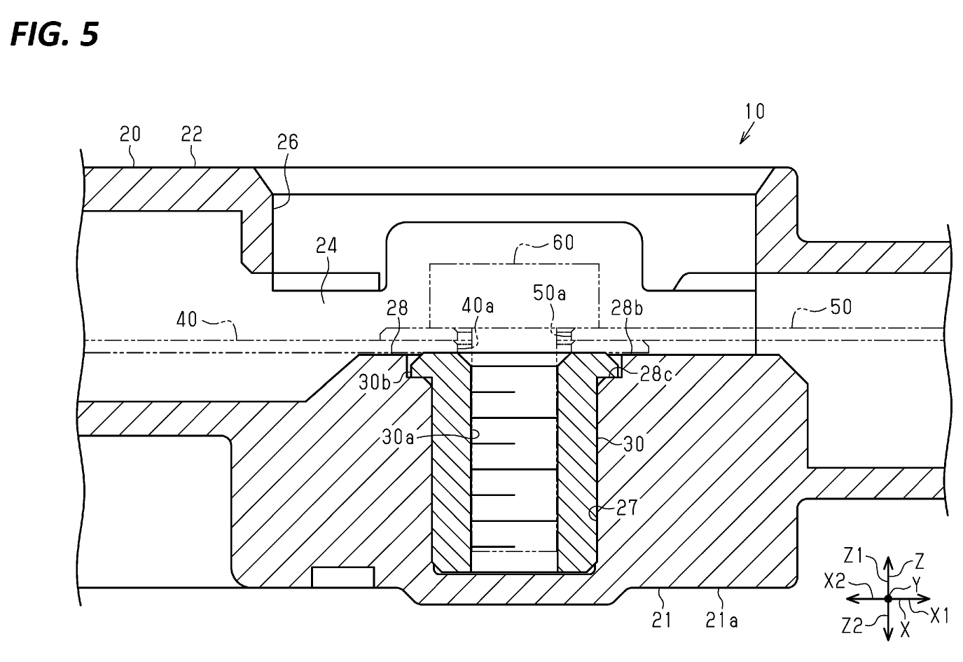

As shown in FIG. 5, the terminal 40 is inserted to a position where the tip part overlaps on the nut 30 in the upward direction Z1, and arranged in the housing 20. Mating terminals 50 are inserted into the housing 20 of this embodiment. The mating terminal 50 includes a through hole 50a in a tip part. The mating terminal 50 is inserted in the first opposite direction X2, which is a direction opposite to the first direction X1, and arranged in each of the parts partitioned by the partition walls 24 in the housing 20. The mating terminal 50 is inserted to a position where the tip part overlaps on the tip part of the terminal 40, and arranged in the housing 20. The mating terminal 50 is connected to the terminal 40 by a bolt 60 passed through the through hole 50a of the mating terminal 50 and the through hole 40a of the terminal 40 and threadably engaged with the internal thread 30a of the nut 30.

### Detailed Configuration of Press-Fitting Portion 27

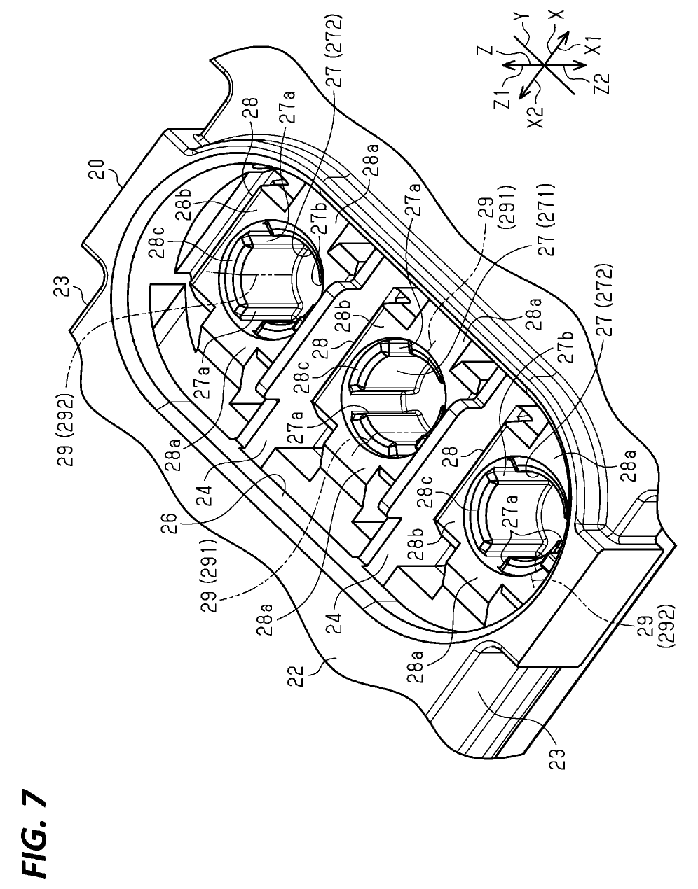

As shown in FIGS. 6 and 7, the press-fitting portion 27 includes grooves 27a recessed radially outward to reduce stress to be applied to weld lines 29 at positions shifted toward the both sides in a circumferential direction with respect to the weld line 29 extending from inner peripheral surface of the press-fitting portion 27. That is, the grooves 27a are provided at positions sandwiching the weld line 29 in the press-fitting portion 27 and recessed radially outward. Note that the weld line 29 is a mark produced during the injection molding of the housing 20 and a mark produced in a confluent part of the molten resin in a mold and having a linear appearance. This weld line 29 is produced according to the shape of the housing 20, the positions of the gates and the like.

In particular, the projecting portion 28 of this embodiment includes a stepped recess 28c recessed from the upper end surface 28b so that the flange portion 30b of the nut 30 can be accommodated, and the press-fitting portion 27 is further recessed in the downward direction Z2 from that stepped recess 28c. The grooves 27a of this embodiment are recessed radially outward from the inner peripheral surface of the press-fitting portion 27 to a radially outer end part of the stepped recess 28c.

Further, the grooves 27a are arranged on the both sides in the circumferential direction with respect to the weld line 29 to be equidistant from the weld line 29 in the press-fitting portion 27. In other words, angular intervals between the weld line 29 and two grooves 27a are set to be equal.

In this embodiment, two weld lines 291 extending in opposite directions along the first axis X are produced in one press-fitting portion 271 in the middle, out of the three press-fitting portions 27. A total of four grooves 27a are formed at positions shifted by an equal distance on both sides in the circumferential direction with respect to each of the two weld lines 291. The four grooves 27a in the press-fitting portion 271 of this embodiment are all provided at equal intervals, i.e. at intervals of 90°.

Further, one weld line 292 inclined with respect to the first axis X and obliquely extending with respect to the second axis Y is produced in each of two press-fitting portions 272 on both sides, out of the three press-fitting portions 27. The grooves 27a are formed at positions shifted by an equal distance on both sides in the circumferential direction with respect to the weld line 292.

Further, the press-fitting portion 272 includes an auxiliary groove 27b recessed radially outward so that a part continuously in contact with the outer peripheral surface of the nut 30 (see FIG. 2) is equal to or less than a half circumference. That is, the two grooves 27a in the press-fitting portion 272 are provided in a range less than 180° with the weld line 292 as a center, and the auxiliary groove 27b is provided on a side where the weld line 292 is not produced between the two grooves 27a.

Further, as shown in FIG. 7, the grooves 27a are formed in the entire range of the press-fitting portion 27 in a press-fitting direction. In particular, the weld line 29 of this embodiment is produced in the entire range from the upper end to the lower end of the press-fitting portion 27. The grooves 27a are formed in the entire range from the upper end to the lower end of the press-fitting portion 27.

### Manufacturing Method of Connector 10

Next, a manufacturing method and functions of the connector 10 configured as described above are described.

The manufacturing method of the connector 10 of this embodiment includes a housing manufacturing step and an assembling step. Further, the housing manufacturing step includes a weld line specifying step, an additional groove designing step and a housing molding step.

In the weld line specifying step, the weld lines 29 produced in the press-fitting portions 27 are specified by a flow analysis. That is, in the weld line specifying step, the positions of the weld lines 29 produced in the press-fitting portions 27 are specified by analyzing a flow of the molten resin injected into the mold from conditions such as the shape of the housing 20 in a state where the grooves 27a are absent and the positions of the gates, using an arithmetic device.

Subsequently, in the additional groove designing step, the grooves 27a recessed radially outward to reduce stress to be applied to the weld line 29 are additionally designed at the positions shifted toward the both sides in the circumferential direction with respect to the weld line 29 specified to extend from the inner peripheral surface of the press-fitting portion 27 in the press-fitting portion. That is, in the additional groove designing step, the grooves 27a of the above embodiment are additionally designed for the shape of the pre-designed housing 20 in the state where the grooves 27a are absent.

Subsequently, in the housing molding step, the housing 20 is molded, using the mold corresponding to the housing 20 having the grooves 27a additionally designed therefor. In this way, the housing 20 is manufactured.

Then, in the assembling step, the nuts 30 and the terminals 40 are assembled with the housing 20 manufactured as described above (see FIG. 2). At this time, the nut 30 is press-fit into the press-fitting portion 27, whereby the outer peripheral surface thereof is held in the press-fitting portion 27. Further, at this time, the flange portion 30b of the nut 30 is accommodated into the stepped recess 28c (see FIG. 5). In this way, the manufacturing of the connector 10 is completed.

### Effects of Embodiment

Next, effects of the above embodiment are described below.
(1) The press-fitting portion 27 includes the grooves 27a recessed radially outward to reduce stress to be applied to the weld line 29 at the positions shifted toward the both sides in the circumferential direction with respect to the weld line 29 extending from the inner peripheral surface of the press-fitting portion 27. Thus, the occurrence of a crack at the weld line 29 in the press-fitting portion 27 can be suppressed, for example, when the nut 30 is press-fit into the press-fitting portion 27. Thus, for example, the nut 30 can be stably held.
(2) Since the grooves 27a are arranged on the both sides in the circumferential direction with respect to the weld line 29 to be equidistant from the weld line 29 in the press-fitting portion 27, stress to be applied to the weld line 29 can be reduced in a well-balanced manner.
(3) The press-fitting portion 272 includes the auxiliary groove 27b recessed radially outward so that the part continuously in contact with the outer peripheral surface of the nut 30 is equal to or less than the half circumference. Thus, the nut 30 can be held in a well-balanced manner. That is, if the press-fitting portion 272 includes a part continuously in contact with the outer peripheral surface of the nut 30 in a range larger than the half circumference without including the auxiliary groove 27b, it may not be possible to hold the nut 30 in a well-balanced manner. However, this can be avoided and the nut 30 can be held in a well-balanced manner.
(4) Since the grooves 27a are formed in the entire range of the press-fitting portion 27 in the press-fitting direction, stress to be applied to the weld line 29 can be further reduced. Thus, the occurrence of a crack at the weld line 29 can be further suppressed.
(5) In the weld line specifying step, the weld line 29 produced in the press-fitting portion 27 is specified by the flow analysis. In the additional groove designing step, the grooves 27a recessed radially outward to reduce stress to be applied to the weld line 29 are additionally designed at the positions shifted toward the both sides in the circumferential direction with respect to the weld line 29 specified to extend from the inner peripheral surface of the press-fitting portion 27 in the press-fitting portion 27. If the connector 10 designed in this way is manufactured, it is, for example, possible to suppress the occurrence of a crack at the weld line 29 when the nut 30 is press-fit into the press-fitting portion 27. Thus, for example, the nut 30 can be stably held.

### Modifications

The above embodiment can be modified and carried out as follows. The above embodiment and the following modifications can be combined with each other and carried out without technically contradicting.
Although the grooves 27a are arranged on the both sides in the circumferential direction with respect to the weld line 29 to be equidistant from the weld line 29 in the press-fitting portion 27 in the above embodiment, there is no limitation to this and distances from the weld line 29 may be different. Note that an angular interval between the weld line 29 and the groove 27a is preferably less than 90°.
Although the press-fitting portion 272 includes the auxiliary groove 27b recessed radially outward so that the part continuously in contact with the outer peripheral surface of the nut 30 is equal to or less than the half circumference in the above embodiment, there is no limitation to this and the auxiliary groove 27b may not be provided.
Although the grooves 27a are formed in the entire range of the press-fitting portion 27 in the press-fitting direction in the above embodiment, there is no limitation to this and the grooves 27a may be formed in a partial range of the press-fitting portion 27 in the press-fitting direction.
Although the manufacturing method of the connector 10 includes the weld line specifying step of specifying the weld line 29 produced in the press-fitting portion 27 by the flow analysis and the additional groove designing step in the above embodiment, this manufacturing method may be changed. For example, the housing 20 in the state where the grooves 27a are absent may be manufactured in a trial manufacturing step, the weld line 29 of the housing 20 in the state where the grooves 27a are absent may be actually measured and the grooves 27a may be additionally designed without performing the weld line specifying step by the flow analysis.
Although the nut 30 includes the flange portion 30b and the projecting portion 28 of the housing 20 includes the stepped recess 28c for accommodating the flange portion 30b of the nut 30 in the above embodiment, there is no limitation to this. For example, the nut 30 may not include the flange portion 30b and the housing 20 may not include the stepped recess 28c.
Although the four grooves 27a in the press-fitting portion 271 are all provided at equal intervals, i.e. at intervals of 90° in the above embodiment, there is no limitation to this and the grooves 27a may be provided at different intervals.
Although the groove 27a is recessed radially outward from the inner peripheral surface of the press-fitting portion 27 to the radially outer end part of the stepped recess 28c in the above embodiment, there is no limitation to this. For example, the groove 27a may be recessed from the inner peripheral surface of the press-fitting portion 27 to a central part in the radial direction of the stepped recess 28c. Further, for example, the groove 27a may be recessed from the inner peripheral surface of the press-fitting portion 27 to a position beyond the radially outer end part of the stepped recess 28c.
Although the weld lines 29 are produced in all the three press-fitting portions 27 in the above embodiment, there is no limitation to this and the weld lines 29 may be produced in only some of the press-fitting portions 27. In this case, the press-fitting portion 27 in which no weld line 29 is produced may not be provided with the grooves 27a and the auxiliary groove 27b. Further, the press-fitting portion 27 in which the produced weld line 29 is relatively small may not be provided with the grooves 27a and the auxiliary groove 27b.
Although the housing 20 includes three gate marks 21b in the lower surface 21a in the above embodiment, there is no limitation to this. That is, the positions of the three gate marks 21b of the above embodiment are just one example and a different number of gate marks may be appropriately set at other positions according to the shape of the housing 20 and the like.
Although the press-fitting member is the nut 30 in the above embodiment, there is no limitation to this and the outer peripheral surface may be changed to the outer peripheral surface of another circular press-fitting member. For example, the press-fitting member may be a hollow cylindrical collar made of metal.
Although the press-fitting portion 27 is formed in the press-fitting portion 28 projecting in the upward direction Z1 from the lower wall 21 in the above embodiment, there is no limitation to this and the press-fitting portion 27 may be formed in another part.
Although the press-fitting portion 27 is recessed in the downward direction Z2 from the upper end surface 28b of the projecting portion 28 in the above embodiment, there is no limitation to this and, for example, the press-fitting portion 27 may be a through hole having no bottom.
Although the connector 10 is provided with three nuts 30 in the above embodiment, there is no limitation to this and a different number of nuts 30 may be provided. Of course, in this case, the number of the press-fitting portions 27 of the housing 20 may be changed.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a press-fitting member having a circular outer peripheral surface; and
a housing made of resin, the housing including a press-fitting portion for holding the outer peripheral surface of the press-fitting member, the press-fitting member being press-fit into the press-fitting portion,
the press-fitting portion including grooves recessed radially outward to reduce stress to be applied to a weld line extending from an inner peripheral surface of the press-fitting portion at positions shifted toward both sides in a circumferential direction with respect to the weld line.

2. The connector of claim 1, wherein the grooves are arranged on the both sides in the circumferential direction with respect to the weld line to be equidistant from the weld line in the press-fitting portion.

3. The connector of claim 1, wherein the press-fitting portion includes an auxiliary groove recessed radially outward so that a part continuously in contact with the outer peripheral surface of the press-fitting member is equal to or less than a half circumference.

4. The connector of claim 1, wherein the grooves are formed in an entire range of the press-fitting portion in a press-fitting direction.

5. A manufacturing method of a connector with:
a press-fitting member having a circular outer peripheral surface; and
a housing made of resin, the housing including a press-fitting portion for holding the outer peripheral surface of the press-fitting member, the press-fitting member being press-fit into the press-fitting portion,
the manufacturing method comprising:
a weld line specifying step of specifying a weld line produced in the press-fitting portion by a flow analysis; and
an additional groove designing step of additionally designing grooves to be recessed radially outward to reduce stress to be applied to the weld line at positions shifted toward both sides in a circumferential direction with respect to the weld line specified to extend from an inner peripheral surface of the press-fitting portion in the press-fitting portion.
